(19) United States
(12) Patent Application Publication
(10) Pub. No.: US 2005/0180684 A1
(43) Pub. Date: Aug. 18, 2005

(54) Optical filter and image display device using the same

(76) Inventor: Toshihisa Kojima, Tokyo (JP)

Correspondence Address: COOPER & DUNHAM, LLP, 1185 AVENUE OF THE AMERICAS, NEW YORK, NY, 10036, US

(21) Appl. No.: 10/516,985

(22) PCT Filed: Jun. 19, 2003
(86) PCT No.: PCT/JP03/07823

(30) Foreign Application Priority Data
Jun. 17, 2002 (JP) 2002206809

(51) Int. Cl. G02B 6/26

(52) U.S. Cl. 385/16

(57) ABSTRACT

An optical filter for preventing the image quality of images displayed on a screen from being degraded in an image display apparatus. The optical filter is disposed on a front side of the screen and is spaced a certain distance from the screen, and has a circularly polarizing filter layer for converting outside light applied thereto into circularly polarized light and limiting the passage of circularly polarized light that is reflected by the screen and that has its direction of polarization inverted.

### TECHNICAL FIELD

The present invention relates to an optical filter and an image display apparatus with such an optical filter, and more particularly to the art of preventing the image quality of images displayed on a screen from being degraded.

### BACKGROUND ART

Some image display apparatus for displaying images on a screen have an optical filter disposed in front of the screen.

One such image display apparatus employs a plasma display panel as the screen. The optical filter has various functions, i.e., prevents radiations, controls light transmittance, control chroma, prevents outside light from being reflected, protects the plasma display panel, and blocks near-infrared rays, etc.

One example of conventional image display apparatus is illustrated below (see FIGS. 4 and 5).

An image display apparatus “a” has various components disposed in a housing “b”.

The housing “b” is in the form of a flat box opening forwardly, for example, and an optical filter “c” is disposed on a front side of the housing “b” (see FIG. 4).

The optical filter “c” includes a laminated assembly of an antireflection film “d”, an adhesive layer “e”, a glass substrate “f”, a dye-containing adhesive layer “g”, and an electromagnetic shield film “h”, which are successively arranged from the front side of the optical filter. The antireflection film “d” and the glass substrate “f” are joined to each other by the adhesive layer “e”, and the glass substrate “f” and the electromagnetic shield film “h” are joined to each other by the dye-containing adhesive layer “g” (see FIG. 5).

The antireflection film “d” and the electromagnetic shield film “h” are made of a resin material, for example.

The antireflection film “d” has a function to lower the reflectance of outside light directed to the optical filter “c”. The glass substrate “f” has a function to protect a screen disposed in the housing “b”. The dye-containing adhesive layer “g” has a function to control the chroma of images displayed on a screen. The electromagnetic shield film “h” has a function to prevent radiations from the screen.

A plasma display panel “i” is disposed as a screen in the housing “b”. The plasma display panel “i” includes two substrates j and k disposed in confronting relation to each other with a discharge space interposed therebetween. The front substrate “j” has a dielectric layer, and the rear substrate “k” has a fluorescent layer.

When the plasma display panel “i” is energized, its temperature increases due to heat generated thereby. The plasma display panel “i” is spaced from the optical filter “c” usually by about 5 mm in order to prevent the antireflection film “d” and the electromagnetic shield film “h”, which are made of a resin material, of the optical filter “c” from being deformed by the heat of the plasma display panel “i”.

A driver circuit 1 for energizing the plasma display panel “i” is disposed behind the plasma display panel “i”.

Since the optical filter “c” and the plasma display panel “i” are spaced a certain distance from each other, the components made of a resin material of the optical filter “c” are prevented from being deformed by the heat of the plasma display panel “i”.

However, because the optical filter “c” and the plasma display panel “i” are spaced a certain distance from each other, the surface of the optical filter “c” reflects outside light, and the surface of the plasma display panel “i” also reflects outside light that has passed through the optical filter “c”. Such two reflections tend to produce double images.

The double images not only make it difficult for the user to see the displayed image, but also cause a reduction in the contrast of the displayed image due to the two reflections.

It is an object of the present invention to prevent the image quality of images displayed on a screen from being degraded.

### DISCLOSURE OF INVENTION

An optical filter according to the present invention has a circularly polarizing filter layer for converting outside light applied thereto into circularly polarized light and limiting the passage of circularly polarized light that is reflected by a screen and has its direction of polarization inverted.

An image display apparatus having an optical filter according to the present invention has a circularly polarizing filter layer, disposed in the optical filter, for converting outside light applied thereto into circularly polarized light and limiting the passage of circularly polarized light that is reflected by a screen and has its direction of polarization inverted.

According to the present invention, therefore, the passage of circularly polarized light, which is reflected by the screen and applied to the optical filter, is limited.

### BRIEF DESCRIPTION OF DRAWINGS

FIG. 1, together with FIGS. 2 and 3, shows an embodiment of the present invention, and is a cross-sectional view of an image display apparatus according to the present invention;

FIG. 2 is an enlarged cross-sectional view showing the structure of an optical filter;

FIG. 3 is a conceptual view illustrative of a function of a circularly polarizing filter layer of the optical filter;

FIG. 4, together with FIG. 5, shows a conventional image display apparatus, and is a cross-sectional view thereof; and

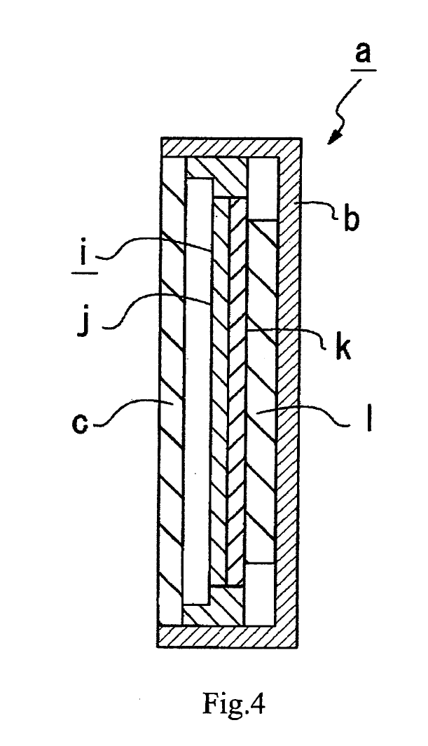

FIG. 5 is an enlarged cross-sectional view showing the structure of an optical filter.

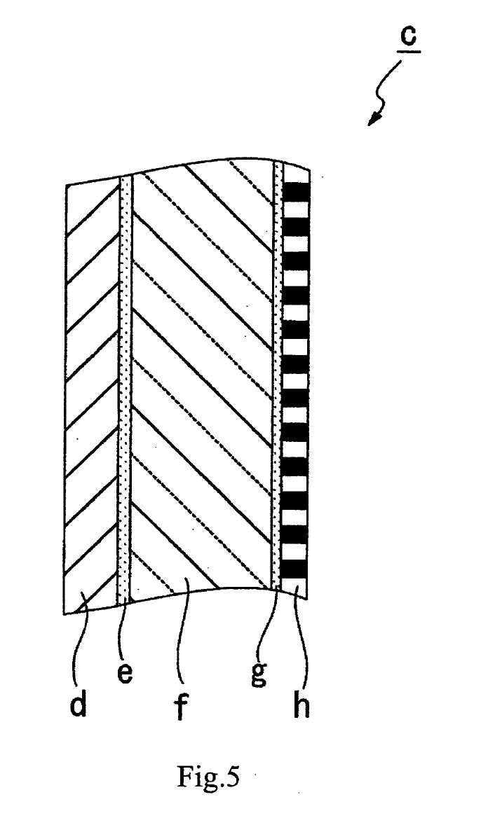

### BEST MODE FOR CARRYING OUT THE INVENTION

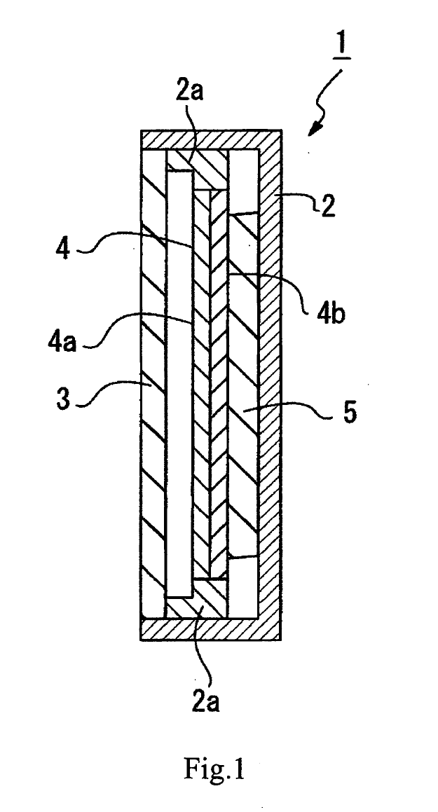

The present invention will be described in detail below with reference to the accompanying drawings (see FIGS. 1 through 3). According to an embodiment described below, the present invention is applied to an image display apparatus having a plasma display panel as a screen.

An image display apparatus 1 has various components disposed in a housing 2.

The housing 2 is in the form of a flat box opening forwardly, for example, and an optical filter 3 is disposed on a front side of the housing 2 (see FIG. 1). Holders 2a and 2a are mounted respectively on inner surfaces of upper and lower walls of the housing 2.

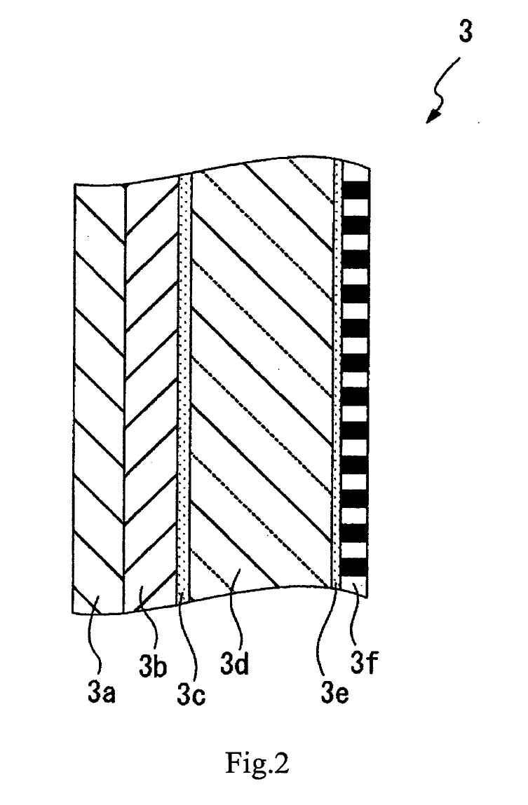

The optical filter 3 includes a laminated assembly of an antireflection film 3a, a circularly polarizing filter layer 3b, an adhesive layer 3c, a glass substrate 3d, a dye-containing adhesive layer 3e, and an electromagnetic shield film 3f, which are successively arranged from the front side of the optical filter. The circularly polarizing filter layer 3b and the glass substrate 3d are joined to each other by the adhesive layer 3c, and the glass substrate 3d and the electromagnetic shield film 3f are joined to each other by the dye-containing adhesive layer 3e (see FIG. 2).

The adhesive layer 3c is made of such a material that its refractive index is substantially equal to the refractive index of the circularly polarizing filter layer 3f and the refractive index of the glass substrate 3d, for thereby reducing the reflection of light that travels from the circularly polarizing filter layer 3f to the glass substrate 3d. Not only the reflection between the circularly polarizing filter layer 3f and the glass substrate 3d, but also the reflectance between layers having different refractive indexes can be reduced by joining (bonding) the layers with an adhesive layer having a refractive index substantially equal to those refractive indexes.

The antireflection film 3a and the electromagnetic shield film 3f are made of a resin material, for example.

The antireflection film 3a has a function to lower the reflection of outside light directed to the optical filter 3. The circularly polarizing filter layer 3b has a function to convert outside light applied thereto into circularly polarized light. The glass substrate 3d has a function to protect a plasma display panel, to be described below, disposed in the housing 2. The dye-containing adhesive layer 3e has a function to control the chroma of images displayed on the plasma display panel. The electromagnetic shield film 3f has a function to prevent radiations from the plasma display panel.

The circularly polarizing filter layer 3b is a light-transmissive layer for converting randomly polarized light applied thereto into circularly polarized light and emitting the circularly polarized light. The circularly polarizing filter layer 3b includes a combination of a linear polarizer positioned on a front side and a ¼ phase difference plate positioned on a rear side, and has a polarizing separation layer and a ¼ phase difference surface.

A plasma display panel 4 is disposed as a screen in the housing 2. The plasma display panel 4 is held by the holders 2a and 2a (see FIG. 1). The plasma display panel 4 includes two substrates 4a and 4b disposed in confronting relation to each other with a discharge space interposed therebetween. The front substrate 4a has a dielectric layer, and the rear substrate 4b has a fluorescent layer.

The plasma display panel 4 is spaced from the optical filter 3 usually by about 5 mm in order to prevent the antireflection film 3a and the electromagnetic shield film 3f, which are made of a resin material, of the optical filter 3 from being deformed by the heat of the plasma display panel 4 (see FIG. 1).

A driver circuit 5 for energizing the plasma display panel 4 is disposed behind the plasma display panel 4.

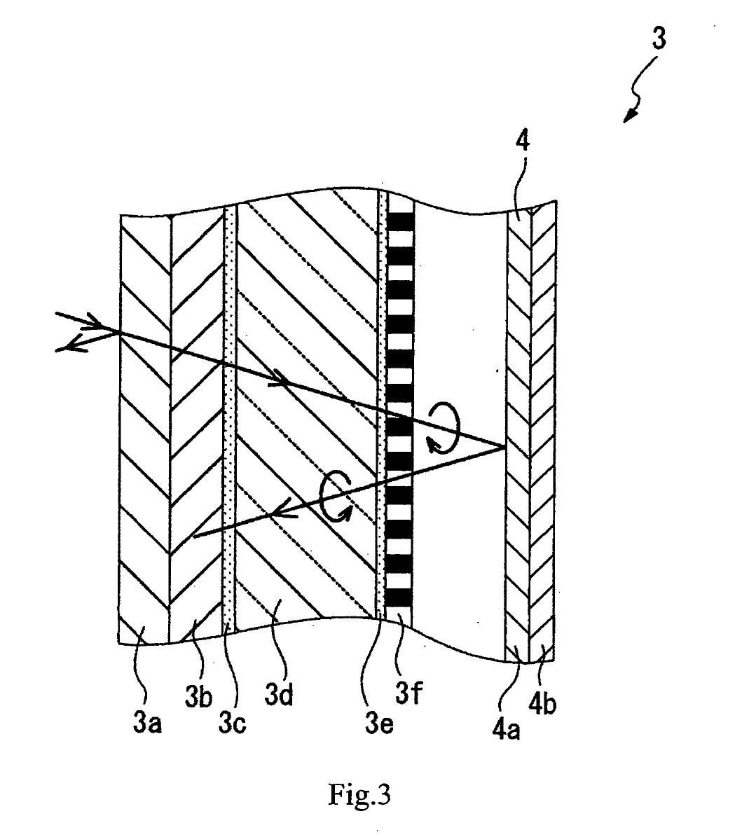

In the image display apparatus 1 thus constructed, outside light (randomly polarized light) directed to the optical filter 2 is reflected in part by the surface of the antireflection film 3a. Of the outside light, light that is not reflected enters the optical filter 2 from the surface of the antireflection film 3a (see FIG. 3).

When the outside light passes through the antireflection film 3a into the circularly polarizing filter layer 3b, linearly polarized light having a certain plane of polarization is separated by the polarizing separation layer of the circularly polarizing filter layer 3b and passes through the polarizing separation layer. Light that does not have the certain plane of polarization is absorbed by the polarizing separation layer. The linearly polarized light having the certain plane of polarization, which has passed through the polarizing separation layer, is converted into right-or left-circularly polarized light by the ¼ phase difference surface of the circularly polarizing filter layer 3b (see FIG. 3).

The right- or left-circularly polarized light passes through the circularly polarizing filter layer 3b to the plasma display panel 4. The right- or left-circularly polarized light directed to the plasma display panel 4 is reflected by the surface of the plasma display panel 4, and is converted thereby into inverted circularly polarized light, i.e., left- or right-circularly polarized light (see FIG. 3). The left- or right-circularly polarized light enters again the circularly polarizing filter layer 3b of the optical filter 3. The left- or right-circularly polarized light that has entered the circularly polarizing filter layer 3b is converted into linearly polarized light having a plane of polarization perpendicular to the above certain plane of polarization by the ¼ phase difference surface, and is absorbed by the polarizing separation layer rather than being emitted out of the optical filter 3 (see FIG. 3).

As described above, the image display apparatus 1 is provided with the circularly polarizing filter layer 3b in the optical filter 3. Accordingly, the passage of the outside light, which is directed to the optical filter 3, from at least part of the optical filter 3 to outside is limited.

Therefore, double images can be eliminated and the contrast can be increased, and the image quality of displayed images is prevented from being degraded.

Since the layout of the optical filter 3 and the plasma display panel 4 remains unchanged, but they are spaced a certain distance from each other, the optical filter 3 is not deformed by the heat of the energized plasma display panel 4. A greater choice of materials for the components of the optical filter 3 such as the circularly polarizing filter 3b is available.

While the circularly polarizing filter 3b has been illustrated as being disposed directly behind the antireflection film 3a, the circularly polarizing filter 3b is not limited to the above position in the optical filter 3, but may be located in any desired position.

The plasma display panel 4 is employed as the screen in the above embodiment. However, the screen is not limited to the plasma display panel 4, but may include a self-emission screen such as a CRT, an electroluminescence display, or the like.

If the plasma display panel 4 is employed as the screen, then since the plasma display panel 4 has its temperature liable to increase when energized and needs to be spaced a certain distance from the optical filter, the present invention as applied to the image display apparatus 1 having the plasma display panel 4 is particularly effective in eliminating double images.

### INDUSTRIAL APPLICABILITY

As is apparent from the above description, the invention described in claim 1 is capable of eliminating doubles images and increasing the contrast of displayed images, and of preventing the image quality of displayed images from being degraded.

The invention described in claim 2 is capable of effectively eliminating doubles images and increasing the contrast of displayed images.

The invention described in claim 3 is capable of eliminating doubles images and increasing the contrast of displayed images, and of preventing the image quality of displayed images from being degraded.

The invention described in claim 4 is capable of effectively eliminating doubles images and increasing the contrast of displayed images.

1. An optical filter disposed in front of a screen, comprising:
a substrate; and
a circularly polarizing filter layer formed on the substrate for converting outside light applied thereto into circularly polarized light and limiting a passage of circularly polarized light that is reflected by the screen and has its direction of polarization inverted.

2. The optical filter according to claim 1, characterized in that said optical filter is spaced a predetermined distance from said screen.

3. The optical filter according to claim 2, characterized in that said screen includes a plasma display panel.

4. The optical filter according to claim 1, wherein said circularly polarizing filter layer includes a combination of a linear polarizer positioned on a front side thereof to which the outside light is applied, and a ¼ phase difference plate positioned on a rear side thereof.

5. The optical filter according to claim 1, wherein said substrate is a glass substrate and said circularly polarizing filter layer is bonded to said glass substrate by an adhesive layer.

6. The optical filter according to claim 1, further comprising an antireflection film disposed on a front side of said circularly polarizing filter layer to which the outside light is applied.

7. The optical filter according to claim 1, characterized in that said screen includes a self-emission screen.

8. An image display apparatus having an optical filter disposed in front of a screen comprising:
a substrate; and
a circularly polarizing filter layer formed on said substrate for converting outside light applied thereto into circularly polarized light and limiting passage of circularly polarized light that is reflected by the screen.

9. The image display apparatus according to claim 8, characterized in that said optical filter is spaced a predetermined distance from said screen.

10. The image display apparatus according to claim 9, characterized in that said screen includes a plasma display panel.

11. The image display apparatus according to claim 8, wherein said circularly polarizing filter layer includes a combination of a linear polarizer positioned on a front side thereof to which the outside light is applied, and a ¼ phase difference plate positioned on a rear side thereof.

12. The image display apparatus according to claim 8, wherein said substrate is a glass substrate and said circularly polarizing filter layer is bonded to said glass substrate by an adhesive layer.

13. The image display apparatus according to claim 8, further comprising an antireflection film disposed on a front side of said optical filter to which the outside light is applied.

14. The image display apparatus according to claim 8, characterized in that said screen includes a self-emission screen.
